(19) United States
(12) Patent Application Publication
(10) Pub. No.: US 2009/0145012 A1
(43) Pub. Date: Jun. 11, 2009

(54) Passively magnetic foil, notice device and use of the notice device

(75) Inventors: Lars Svensson, Stockholm (SE); Gert Karlsson, Enskede Gard (SE); Kent Lundin, Huddinge (SE); Ingemar Drakensjo, Enebyberg (SE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: GRINDFILL AB

(21) Appl. No.: 12/320,676

(22) Filed: Feb. 2, 2009

Related U.S. Application Data
(62) Division of application No. 10/545,789, filed on Sep. 5, 2006.

(30) Foreign Application Priority Data
Feb. 21, 2003 (SE) 0300484-3

(51) Int. Cl. G09F 7/04

(52) U.S. Cl. 40/600

(57) ABSTRACT

The present invention relates to a passively magnetic foil (1) that comprises at least one layer (2). Said layer (2) includes at least one polymer material and at least one iron material, whereby the iron material constitutes 50-80% by weight. The present invention also relates to a notice device for posting information, advertisements or the like on a supportive structure and comprising the passively magnetic foil (1) according to the aforesaid, and also a use of the notice device.

The present invention relates to a passively magnetic foil including at least one layer. The invention also relates to a notice device for posting information, advertisements or the like on a supportive structure and use of the notice device.

### PRIOR ART

Metal notice boards for posting messages with the aid of different types of magnets are generally known in the art. These notice boards are based on the concept of constructing the actual notice boards from a passively magnetic material, while using actively magnetic permanent magnets for posting messages on the board. The magnets exert their retaining force locally in respective contact surfaces with the substrate. The retaining force exerted by reasonably large magnets is less beneficial in respect of demanding environments and applications. The magnets are easily lost and in the absence of magnets messages that are printed on paper, for instance, cannot be posted on a metal notice board.

WO, A1, 99/18158 shows a passively magnetic polyester composition that can be used to produce sheet material by means of extrusion processes. The sheet products are usable in applications that require attraction in a magnetic field. The attraction is, however, much too weak to suit many conceivable applications.

DE, A1, 197 39 174 shows a magnetic foil. At least one surface/layer thereof exhibits actively magnetic properties. This foil, however, has the drawback of being excessively expensive in manufacture and use as a carrier of messages that shall be posted and changed often.

### SUMMARY OF THE INVENTION

A first object of the invention is to provide a foil, which is able to function as a carrier of information to be posted and, at the same time, to provide good attraction in a magnetic field, in other words the foil shall not be actively magnetic/permanently magnetic in itself. A second object of the invention is to provide a foil which can be produced and used inexpensively. A third object of the invention is to provide a foil that can be put in place and removed with the greatest speed and with the smallest risk to human health. A fourth object of the invention is to provide a foil that can be destroyed or recovered easily, without having a deleterious effect on the environment.

The invention thus relates to a passively magnetic foil including at least one layer. Said layer comprises at least one polymer material and at least one iron material, the iron material constituting 50-80% by weight.

Said iron material may consist of pure iron and/or of one or more available iron compounds that have passively magnetic properties. Said polymer material may include one or more of the following materials: polypropylene, polyethylene, copolymer with polypropylene, copolymer with polyethylene, copolymer with polypropylene and polyethylene, and also other thermoplasts.

The aforesaid layer may include at least one additive material. Said additive may be titanium dioxide, TiO₂, chalk CaCO₃, talcum, ground glass or other available fillers. When polypropylene is used as the polymer material, said layer may have a density of 1.50-3.01 g/cm³. Said layer may be coated with at least one coating material on at least one side, whereby said coating forms at least one further layer on said layer. Said coating material may be constituted by titanium dioxide mixed with at least one thermoplast and/or of at least one other filler mixed with at least one thermoplast so as to achieve opacity and/or whiteness. Said coating material may consist of a solvent-based polymeric binding agent that will impart a long storage time to the foil prior printing with printing ink or the like of the foil. The foil may have a total thickness of 0.1-2.5 mm.

The invention thus also relates to a notice device for posting information, advertisements or the like on a supportive structure, and comprising the passively magnetic foil according to the aforegoing. The notice device includes at least one actively magnetic substrate fastened to said structure and at least one piece of the passively magnetic foil applied to the substrate, whereby the information, advertisement(s) or the like is/are printed on the passively magnetic foil.

The invention also relates to the use of the notice device according to the aforegoing, wherein said actively magnetic substrate is fastened to an appropriate supporting structure, such as an indoor or outdoor wall, on a notice board that is free-standing or fastened to some other substrate, on part of a vehicle, such as a car, a bus, the carriage of a subway, the carriage of a train or the like and/or on a road sign.

### LIST OF DRAWINGS

FIG. 1 shows, in a cross-sectional view, a first embodiment of an inventive foil;

FIG. 2 shows, in a cross-sectional view, a second embodiment of the inventive foil.

### DESCRIPTION OF EMBODIMENTS

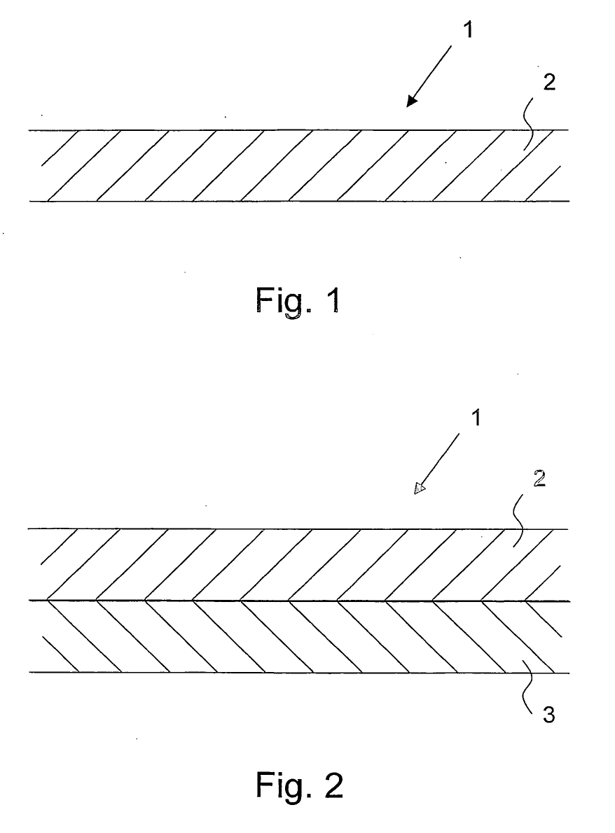

FIG. 1 illustrates the structural make-up of a first embodiment of the foil 1 according to the invention. The foil 1 consists of only one layer 2 which comprises both a polymer material and an iron material. The iron material corresponds to 50-80% by weight of the material in the layer 2 and most preferably about 70% by weight. The layer 2 has a thickness of 0.03-0.20 mm. The iron material is present in the form of pure iron and/or one or more of the existing iron compounds having passively magnetic properties, such as iron oxide, hematite and magnetite. In turn, the polymer material is one or more of polypropylene, polyethylene, copolymer with polypropylene, copolymer with polyethylene, copolymer with polypropylene and polyethylene, and finally other thermoplasts. The polymer normally used is polypropylene. Thermoplasts can be chosen due to a desire for better wear properties, enhanced elasticity modules and/or bending modules, thermal tolerance or other features.

Additive material may be present in the layer 2, for instance, in the form of a dispersant and/or other additives, such as titanium dioxide TiO₂, chalk CaCO₃, talcum Mg₃Si₄(OH)₂, ground glass and/or other available fillers.

FIG. 2 illustrates the structural make-up of a second embodiment of the foil 1 according to the invention. In addition to the aforesaid layer 2, a further layer 3 is present that has a coating material consisting of titanium dioxide TiO₂ mixed with a thermoplast. The further layer 3 with titanium dioxide has a thickness of 10-20 μm and may replace additive material in the form of titanium dioxide in the layer 2, either totally or partially. Instead of titanium dioxide mixed with a thermoplast, the further layer 3 may consist of polypropylene and/or polyethylene, that has been given a surface tension ≧40 dyne/cm by a so called corona treatment so as to make subsequent printing or lamination possible. Instead of one of said materials, the further layer 3 may consist of a solvent-based polymeric binder that will impart a long storage time to the foil prior to printing (with printing ink). Said solvent-based polymeric binder may also be applied to the further layer 3 in one of its aforesaid variants, therewith resulting in a foil that comprises three layers. Irrespective of the number of layers present in the foil, the foil shall have a thickness of 0.1-2.5 mm.

Iron, iron compounds, nickel and cobalt exhibit a high ferromagnetism of passive type. Magnetic flux density can be expressed as β=4π×I, where I is the magnetic moment per unit of volume, whereby I is 218 in the case of iron, 54.39 in the case of nickel and 161 in the case of cobalt. Iron is therefore the best. The concentration of iron material desired in the layer 2 will depend on the thickness of the layer 2 and on the distance to an actively magnetic surface. The actively magnetic material should be of an isotropic type. A smallest critical density per unit of surface area of the foil 1 is necessary in order to achieve a desired effect in the form of good magnetic attraction in a magnetic field. For reasons of a technical nature, concentrations of 50-80% by weight of said iron material are used in the layer 2. The following relationship applies with respect to density,

$$\frac{1}{{ρ}_{tot}} = \frac{{X}_{i}}{{ρ}_{poly}} + \sum \frac{{Y}_{i}}{{ρ}_{oorg}}$$

where ρₜₒₜ is the total density of the material, Xᵢ is the polymer concentration, ρ_{poly} is the polymer density. Yᵢ is the concentration of inorganic components and ρ_{oorg} is the density of in-organic components, said density being expressed as g/cm³ and concentration being expressed by % by weight.

### Example

In the case of 50% by weight of Fe₃O₄ in the polypropylene, the density is 1.53 g/cm³, and in the case of 80% by weight Fe₃O₄, the density is 2.65 g/cm³. In the case of 50% by weight Fe(s) in the polypropylene, the density is 1.60 g/cm³, and in the case of 80% by weight Fe(s), the density is 3.01 g/cm³. (In respect of iron, the density is 7.3-7.8 g/cm³, whereas for magnetite and hematite, the density is 5.2 g/cm³. Magnetite has the chemical formula Fe₃O₄ and hematite Fe₂O₃.)

The inventive foil provides good attraction in a magnetic field. It is produced and used cheaply. It may be applied to and removed from any appropriate substrate quickly, without the need of tools, glue or the like, and for this reason the effect on personal health is small. The foil may be destroyed or recovered readily and with no deleterious effect to the environment.

The foil is produced in the following way:

Polymer material and iron material of the earlier described kind are compounded to a granulate form. Additive(-s) is/are used in this process, in order to improve dispersion. There is preferably used an iron powder that has a particle size of 1-70 microns. The granulate shall contain 50-80% by weight iron material. The granulate is then processed in an extruder and blown or flat-faced extruded as foil (film). Titanium dioxide may optionally be added in this step in the form of chalk, so as to obtain a smooth printable light surface for printing with printing ink.

The extrusion may be effected in one or more layers. When only a single layer 2 is produced in the extrusion process, solely the passively magnetic layer 2 will be obtained in the foil 1. When one or more additional layers 3 are present it/they may be present on one or both sides of the passively magnetic layer 2 in the foil 1, that is to say one or more additional layers 3 may be present on one side of the passively magnetic layer 2 and one or more additional layers 3 may be present on the other side of said passively magnetic layer 2, independently of each other. One or more additional layers 3 may consist of titanium dioxide mixed with at least one thermoplast and/or of at least one other filler mixed with at least one thermoplast, although other substances may also be considered. This enables different types of foil to be produced, e.g. foils that are white on both sides or white on one side and grey on the other side, and/or coated with material other than titanium dioxide on one and/or the other side. The foil is corona-treated for printability and may, as before mentioned, be coated with a solvent-based polymeric binder that functions to reduce surface tension. A neutral binder that has a broad area of use is used. This binder is, for instance, applied with the aid of a spiral applicator. Anti-static treatment may also be applied. The end product may be delivered in the form of a continuous web or may be cut to size in accordance with customer wishes.

### Example 1

There is produced a compounded material of 80% by weight pure iron Fe(s) and 20% by weight of a copolymer of ethylene-vinyl acetate having an apparent density of 2.6 g/cm³. The particles have a size of 45-75 microns. The compounded material is mixed with 15% by weight of copolymer of polypropylene. A foil is extruded in a spiral mandrill type film blowing head, together with an outer layer on each side of the foil. Each of these outer layers comprises 92% by weight polypropylene and 8% by weight pure titanium dioxide such as to achieve whiteness. The foil is corona-treated to 42-44 dyne/cm and printed.

### Example 2

Magnetite, Fe₃O₄, was compounded to obtain a finished material that has a density of 2.91 g/cm³. Carriers are a polypropylene block copolymer and polyethylene. 94% by weight of said compounded material is mixed with 6% by weight of a polypropylene homopolymer. This compounded material is extruded to a thickness of 0.12 mm as an intermediate layer between two transparent non-modified layers. As a result of its magnetic attraction, the resultant foil is found to have good adhesion to an actively magnetic surface. The functional three-ply foil may be laminated with 0.10 mm thick white-coloured polypropylene and also then shows good attraction or adhesion properties.

The inventive notice device for posting information, advertisements or the like on a supportive structure includes the passively magnetic foil according to the aforegoing. An actively magnetic substrate in the form of a sheet of permanent magnetic material is fastened to the rearwardly lying supportive structure in an appropriate known manner. The appropriate known manner, comprises gluing and/or mounting with different types of fasteners, such as screws, nails, hooks or the like.

A piece of the passively magnetic foil is applied to the permanent magnetic sheet and there retained by magnetic action. The information, advertisements or the like is/are printed on the passively magnetic foil.

When using the inventive notice device in accordance with the aforegoing, the actively magnetic substrate is fastened to a suitable supportive structure, such as an internal wall or external wall of a building, on a board which is free-standing or fixed to another substrate, on part of a conveyance vehicle, such as an automobile, a bus, a subway carriage, a train carriage or the like and/or on a road sign. The inventive notice device can also be used in connection with different types of games and in connection with mounting of drawings, charts, maps, sea charts and the like.

The principle on which the present invention is based may also be applied to fasten abrasive cloth, emery paper, polishing cloth and/or polishing paper or the like to the working part of a machine tool. In that case the abrasive cloth or equivalent is constituted by a passively magnetic foil according to the invention while the working part of the machine tool shows actively magnetic properties making it possible for the abrasive cloth or equivalent to be fastened to the working part of the machine tool solely with the aid of magnetic action.

Said polymer material may be of any appropriate known kind whatsoever. Mixtures of two or more polymer materials may also be used. By the expression foil is also meant film of suitable thicknesses. Nickel and/or cobalt material may be used together with or instead of iron material in the passively magnetic foil according to the invention.

The invention is not restricted to the illustrated embodiments, but can be varied within the scope of the accompanying claims.

1-11. (canceled)

12. A method of posting information which comprises the steps of (1) affixing an actively magnetic substrate on a support structure, and (2) applying a passively magnetic foil having information thereon to the actively magnetic substrate for display of the information, the passively magnetic foil including a base layer containing a polymer material and 50-80% by weight iron material, and a coating layer on at least one side of said base layer.
